(19) United States
(12) Patent Application Publication
(10) Pub. No.: US 2012/0203887 A1
(43) Pub. Date: Aug. 9, 2012

(54) SYSTEMS AND METHODS FOR DISTRIBUTED OFFLOAD OF EXECUTION PATH MONITORING

(75) Inventor: Martin JULIEN, Laval (CA)

(73) Assignee: TELEFONAKTIEBOLAGET L M ERICSSON (PUBL), Stockholm (SE)

(21) Appl. No.: 13/022,079

(22) Filed: Feb. 7, 2011

(51) Int. Cl. G06F 15/173

(52) U.S. Cl. 709/224

(57) ABSTRACT

Systems and methods provide for the processing of data including monitoring functions. A blade enclosure for processing data includes: at least one first blade server configured to only perform routine processing tasks; and at least one second blade server connected to the at least one first blade server and configured to perform monitoring functions, wherein the at least one first blade server is configured to offload received data which requires monitoring to the at least one second blade server, and wherein the routine processing tasks do not include monitoring functions.

### TECHNICAL FIELD

The embodiments of the subject matter disclosed herein generally relate to networking systems and more particularly relate to monitoring functions in systems.

### BACKGROUND

During the past years, the interest in using mobile and landline/wireline computing devices in day-to-day communications has increased. Desktop computers, workstations, and other wireline computers currently allow users to communicate, for example, via e-mail, video conferencing, and instant messaging (IM). Mobile devices, for example, mobile telephones, handheld computers, personal digital assistants (PDAs), etc., also allow users to communicate via e-mail, video conferencing, IM, and the like. Mobile telephones have conventionally served as voice communication devices, but through technological advancements they have recently proved to be effective devices for communicating data, graphics, etc. As user demand for seamless communications across different platforms increases, which in turn creates more usage, and leads to more services and system improvements it is expected that wireless and landline technologies will continue to merge into a more unified communication system in support of such demand.

Various systems and methods have been used to deliver and/or request information between devices, nodes and networks in support of customer demand. In the context of networking applications and components, such as routers and gateways, networking systems are processing an increasing amount of data bandwidth year after year. With the rapidly growing popularity of the Internet on fixed and mobile networks, many networking systems often need to process more data, offer more bandwidth and to quickly introduce more features to the system while minimizing any negative impact on the currently existing capabilities of the systems themselves.

As new features are developed, a significant amount of feature and system testing is typically performed. The purpose of this extensive testing phase is mainly to validate the new features and to understand their impact on the rest of the system's resources. This extensive testing phase can also occur when existing features and/or functions need to be upgraded or removed. Monitoring functions can be provided to assist in validating these features and functions associated with the system. Monitoring functions can include debugging, tracing and logging capabilities as well as optional statistical and resource usage information. Additionally, monitoring functions can be enabled or disabled as desired.

Monitoring functions are typically employed in networking systems with specific logic associated with these monitoring functions typically included in each application. In other words, monitoring functions are normally intrusive to the logic of applications. Thus when monitoring functions are enabled a processed packet would go through its “normal” processing, e.g., associated with an application and some monitoring processing on the same processing component. This can become very complicated to validate in the context of a traffic mix where several features may be called upon sequentially or in parallel as well as extremely demanding on processing resources. Further adding to the potential complexity is that the monitoring application's features can be performed on a feature basis, on a packet flow basis or on an application basis. This could become extremely challenging to introduce more traffic scenarios involving monitoring functions as their impact on the system could be significant with respect to the impact on the system's resources. This can lead to other problems as well, such as, errors occurring in features when they use monitoring functions, which in turn is not helpful in validating the features themselves.

The impact on performance for such debugging, tracing or debugging type of monitoring functions could thus be significant for a system. For example, assume that a processing component is capable of sustaining 100 Gbps of data traffic bandwidth when the monitoring functions are disabled, the same processing component may only be capable of sustaining 10 Gbps of data traffic bandwidth when the monitoring functions are enabled. In this example, 90% of the data bandwidth capacity of the processing component would not be available for processing new packets, which would instead be dropped.

One solution to this problem is to have a system with a committed data bandwidth for applications, with the dimensioning of the system generally depending on the level of support for monitoring functions desired. For example, assuming that the processing capacity required for monitoring application is twice the processing capacity required without monitoring, a system might require twice the number of processing components in order to sustain its committed data bandwidth. While this solution is possible, it can be expensive as well as wasteful of hardware resources.

Accordingly, systems and methods for providing monitoring functions in systems are desirable.

### SUMMARY

Exemplary embodiments describe offloading information from routine processing components, for which it is desirable to monitor, to reserved processing components which are capable of performing the monitoring functions. By performing the monitoring functions on the reserved processing components the limited bandwidth of a system can be preserved for routine processing.

According to an exemplary embodiment there is a blade enclosure. The blade enclosure includes: at least one first blade server configured to only perform routine processing tasks; and at least one second blade server connected to the at least one first blade server and configured to perform monitoring functions, wherein the at least one first blade server is configured to offload received data which requires monitoring to the at least one second blade server, and wherein the routine processing tasks do not include monitoring functions.

According to another exemplary embodiment there is a method for processing data by a blade enclosure. The method includes: performing, by at least one first blade server, only routine processing duties; performing, by the at least one second blade server, monitoring functions; and offloading, by the at least one first blade server, received data which requires monitoring to the at least one second blade server, and wherein the routing processing tasks do not include monitoring functions.

### BRIEF DESCRIPTION OF THE DRAWINGS

The accompanying drawings illustrate exemplary embodiments, wherein:

FIG. 1 depicts a blade server according to exemplary embodiments;

FIG. 2 illustrates offloading data which requires monitoring according to exemplary embodiments;

FIG. 3 shows distributed offloading scheme according to exemplary embodiments;

FIG. 4 shows a processing component according to exemplary embodiments; and

FIG. 5 shows a method flowchart according to exemplary embodiments.

### DETAILED DESCRIPTION

The following detailed description of the exemplary embodiments refers to the accompanying drawings. The same reference numbers in different drawings identify the same or similar elements. Additionally, the drawings are not necessarily drawn to scale. Also, the following detailed description does not limit the invention. Instead, the scope of the invention is defined by the appended claims.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

As described in the Background section, there is a need to provide systems and methods for providing monitoring functions in systems which do not generate the problems previously described. According to exemplary embodiments, one method for minimizing the impact of monitoring functions on critical processing components can include having packets which require monitoring functions being distributed among processing components dedicated to monitoring functions. For example, whenever a processing component detects that a packet, or a packet flow, would require monitoring functions that could compromise its ability to sustain its committed data bandwidth, the packet could be transferred to another processing component dedicated to that task. Alternatively, anytime the processing component detects that a packet, or a packet flow, would require monitoring functions the packet could be transferred to another processing component dedicated to that task. As the monitoring functions are performed on dedicated processing components, it becomes possible to minimize the impact of monitoring functions on features not requiring such monitoring capabilities. According to exemplary embodiments, the distribution scheme can be based on the availability of monitoring enabled, dedicated processing components, on the processing workload estimate for monitoring a particular execution path, the specific configuration of a system in terms of resource management or some combination thereof.

According to exemplary embodiments, one processing component with its monitoring functions disabled (or not present) can offload the processing of packets requiring monitoring to one or more dedicated processing components which is reserved for monitoring. In support of this offloading, it can be desirable to ensure that the introduction of the monitoring functions on the dedicated processing component(s) does not change the expected processing of the packets. Therefore, according to one exemplary embodiment, the same logic associated with routine processing can be executed on both processing components with monitoring functions enabled and disabled. For example, two versions of the same execution path can exist on a system: one with the monitoring functions disabled and one with the monitoring functions enabled. Additionally, the same source code and the same execution environment could be on both processors, e.g., the processor for performing routine functions and the processor with monitoring functions enabled, in order to minimize the differences between the two processors. According to an exemplary embodiment, this can allow the two processors to have the same compiled binary code in order to avoid having two different versions of the software running in the two processors. This can assist in eliminating possible differences in the generated compiled code due to different compiler optimizations.

According to exemplary embodiments, larger networking systems are typically built from a number of smaller components such as processing components, switching components and input/output (I/O) cards. This concept of building large systems by integrating smaller components supports the scalability requirements of such a large system as well as assisting in cost optimization via economies of scale. In relation to the monitoring functions, processing components specifically dedicated to monitoring functions can be integrated into networking systems, in addition to the components normally required to process and sustain the committed data bandwidth specified for the system. This may be done in order to process and sustain the data bandwidth for packets requiring the monitoring functions processing components specifically dedicated to monitoring functions. Thus, the networking system can sustain the same amount of traffic with or without the activation of monitoring functions. For this case it is to be understood that the system capacity for monitoring functions is dependent upon the extra capacity provided by the additional monitoring capable processors. Additionally, when monitoring, the features being monitored can have a minimal impact (or be transparent) on features not being monitored.

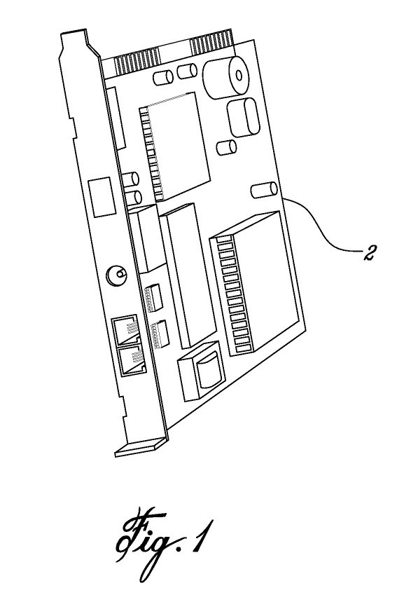

One example of a system in which monitoring functions can be desirable is a web server (or a plurality of networked web servers). The web server can be hosted by one or more blade servers which are contained in a blade enclosure. Blade servers are individual servers with stripped down components when compared to traditional servers. Each blade server can include one or more processors, memory as well as software and applications. An example of a blade server 2 is shown in FIG. 1. Other functions, e.g., cooling and power, are provided by the blade enclosure. According to exemplary embodiments, blade servers can be configured to support monitoring functions in a manner to provide minimal or zero impact on the other routine functions which are currently ongoing. For example, when a web server implements a new feature, monitoring functions can be implemented without a user seeing a negative impact on their end, e.g., no loss of data bandwidth is seen by the user. Examples of monitoring functions include debugging, tracing, logging functions as well as capabilities related to the collection and publication of information about packets and a system's resources. In the context of this application “routine processing” refers to processing except the processing of monitoring functions. For a purely illustrative example of routine processing, consider a scenario where a web server receives a request from a user which is a request to access a link to a feature hosted by the web server. The web server then processes the request and accesses the link to the feature for the user. Additionally, when using the phrase “processing component” it is to be understood that a blade server is a non-limiting example of a processing component on which exemplary embodiments can be supported.

According to exemplary embodiments, in order to minimize the impact of monitoring functions on critical processing components, packets requiring monitoring functions can be delegated to the processing components dedicated to monitoring functions. By performing the offloading of monitoring functions to dedicated processing components, it is possible to scale a system specifically based on requirements for monitoring capabilities. One way this can be done is by estimating the impact of monitoring functions on processing components and then dimensioning the number of dedicated processing components required by such monitoring functions, depending on the system's needs for such a capability. In other words, depending on the monitoring requirements on the data traffic, one processing component with monitoring functions disabled could be offloading the processing of packets to be monitored to another dedicated processing component with monitoring capabilities.

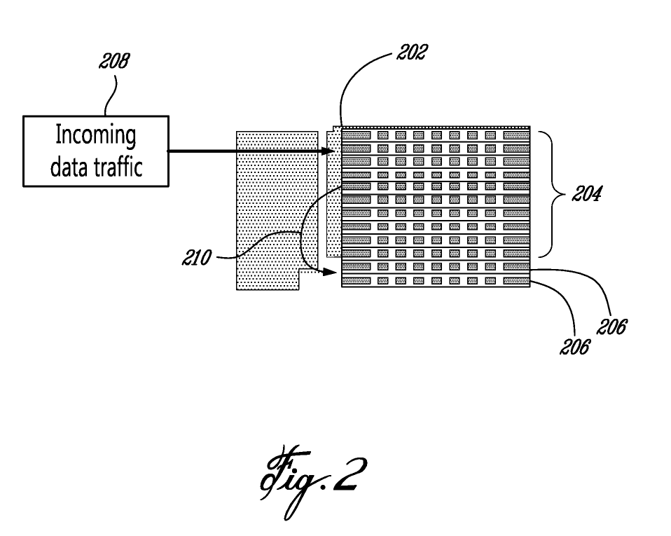

According to exemplary embodiments, an example of offloading is now described with respect to FIG. 2. FIG. 2 shows a blade enclosure 202, blade servers for routine processing 204 (which may not include any monitoring functions or may have them disabled) and blade servers reserved for monitoring functions 206. Initially, incoming data 208 is received by the blade enclosure 202 and sent to one of the blade servers for routine processing 204 which determines that the incoming data 208 should undergo monitoring. The one of the blade servers for routine processing 204 which performed the determination then offloads the incoming data to at least one of the blade servers reserved for monitoring functions 206 which then performs the monitoring function(s).

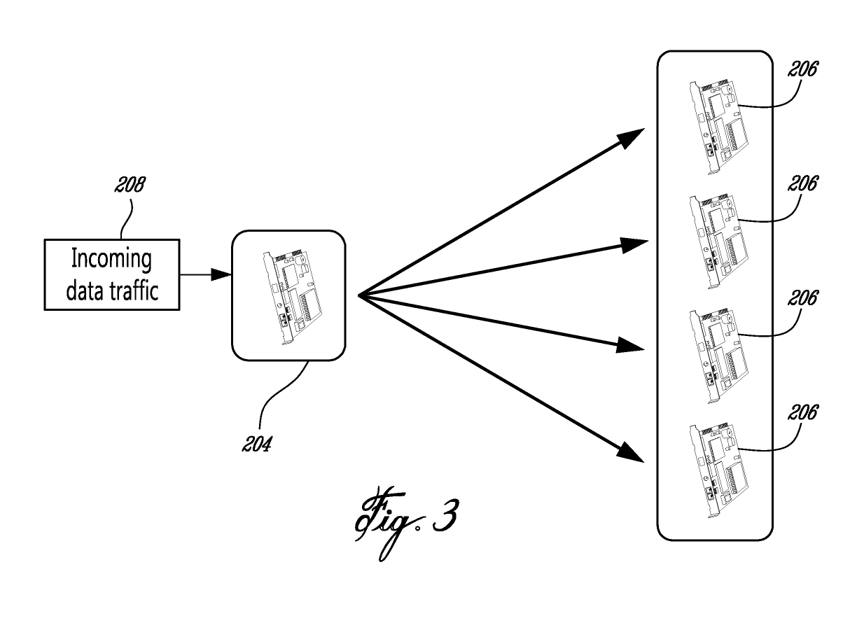

According to another exemplary embodiment, in order to provide a scalable solution for monitoring functions, one processing component with monitoring functions disabled could be offloading the processing of packets to one or more dedicated processing components. This offloading of the monitoring functions among server processing components can be based on a distribution scheme or an algorithm. For example, consider FIG. 3 which shows an incoming data stream 208 being received by a blade server for routine processing 204. The blade server for routine processing 204 decides to offload the data to four blade servers reserved for monitoring functions 206. While in this example four blade servers reserved for monitoring functions 206 are shown, the system can have more or fewer blade server reserved for monitoring functions as desired in order to sustain the system's bandwidth. Additionally, according to exemplary embodiments, this distribution of the offloading can be based upon the availability of monitoring enabled dedicated processing components, on the processing work load estimate for monitoring a particular execution path, the specific configuration of a system in terms of resource management or some combination thereof.

According to exemplary embodiments, when monitoring functions would be required for a packet, the packet could be transferred to a dedicated processing component for monitoring, where the execution path would be processed as expected, with additional processing for the support of monitoring. The dedicated processing component will have its monitoring functions enabled in order to minimize the impact on the processor where the packet was originally received.

According to another exemplary embodiment, applications can be configured to make the offload scheme optional or tailored for the applications' needs. For example, in one case the monitoring offload could be disabled, while in another case the monitoring functions could be partitioned between routine processing components and processing components with dedicated monitoring functions. For example, some monitoring functions could be performed by the routine processing component and the monitoring functions which require more processing capabilities could be distributed to monitor dedicated processing components.

According to exemplary embodiments, in some cases when offloading different packet flows to multiple processor components with dedicated monitoring functions when the different packet flows have some form of dependency (possibly related to configuration, and/or provisioning) and/or persistent data, additional controls may be needed. For example, the persistent data may need to be managed in which case the monitoring enabled dedicated processing components may be synchronized with the processing components where the monitoring functions are disabled. Depending upon the data model implemented on a system, the synchronization of the data model on the dedicated processing components could be relatively simple or relatively complicated. For example, there can be situations where one or more monitoring enabled processing components may need to be synchronized with a unique non-enabled monitoring processing component. According to an exemplary embodiment when a minimal amount of synchronization is desired, synchronization information can be prepended to the packets being sent to and/or from the processing component where the monitoring functions are disabled to the monitoring enabled dedicated processing component in order for the monitoring functions to perform as desired. However, there could also be situations where the persistent data would be shared among all of the processing components, which could make the synchronization unnecessary. In cases where a monitoring disabled processing component could need to distribute packets to one or more monitoring enabled processing components, it may be that only a subset of the persistent data model would have to be synchronized between the processing components. Alternatively, based on the specific application, it may not be possible to distribute the packet flows to multiple processing components in which case a single monitoring enabled dedicated processing component can be used.

According to another exemplary embodiment, in situations where no monitoring enabled processing components would be available, either because they would be missing or already used at their maximum capacity, all of the monitoring functions could be executed on the processing components which typically perform routine processing, some portion of the monitoring functions could be executed on the processing components which typically perform routine processing or the monitoring functions may not be executed.

According to exemplary embodiments, the dedicated processing components with monitoring functions, e.g., blade servers reserved for monitoring functions 206, can be optimized with special hardware components, e.g., special or additional processors, as well as software based functions in order to provide more efficient monitoring capabilities. For example, a variant of the same processor, used by the processing component without monitoring functions, which is more powerful in terms of processing capacity can be used. This processing component can also, or alternatively, include additional capabilities for advanced and high-capacity functions for monitoring. According to an exemplary embodiment, this so-called “special” processing component would typically be more expensive and potentially less energy efficient, therefore it may be desired to use this special processing component only to monitor enabled processing components. Additionally, if errors are encountered because of the monitoring functionality, only the monitored traffic is impacted.

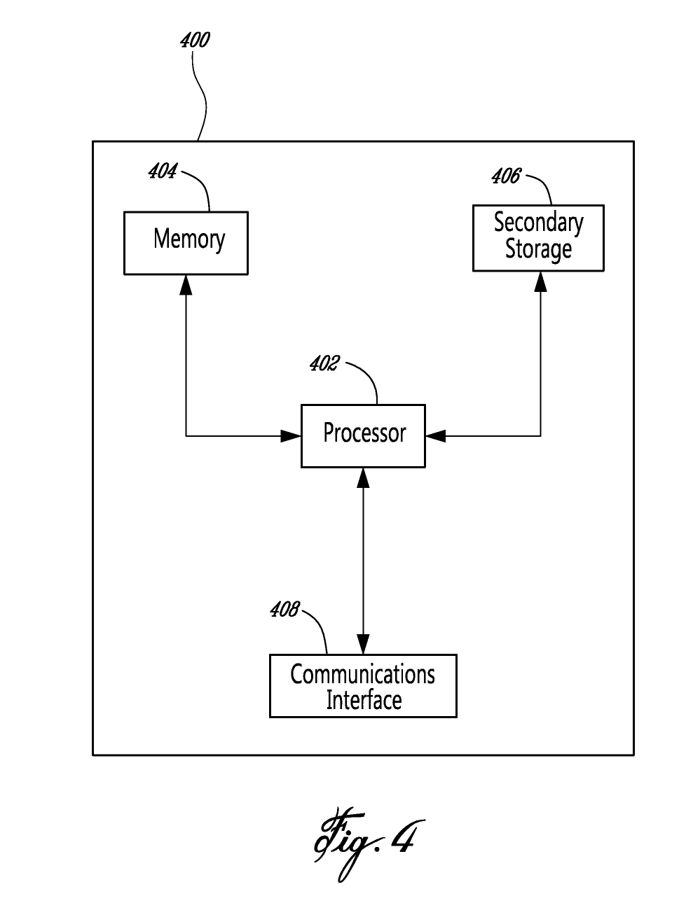

The exemplary embodiments described above provide for the offloading of traffic which requires monitoring to a processing component, e.g., a blade server with appropriate processors and/or software for performing monitoring, with monitoring functions enabled. An exemplary processing component, which can be the blade server reserved for monitoring 206, will now be described with respect to FIG. 4. The processing component 400 can contain a processor 402 (or multiple processor cores), memory 404, one or more secondary storage devices 406 and an interface unit 408 to facilitate communications between the processing component 400 and an enclosure, e.g., the blade enclosure 202. The processor 402 can execute instructions to facilitate the exemplary embodiments described above with respect to the monitoring functions described herein. Memory 404 can be used to store information associated monitoring functions, including specialized software which support monitoring functions as well as for storing persistent state information as desired. Thus, processing component 400 can perform the exemplary embodiments described herein.

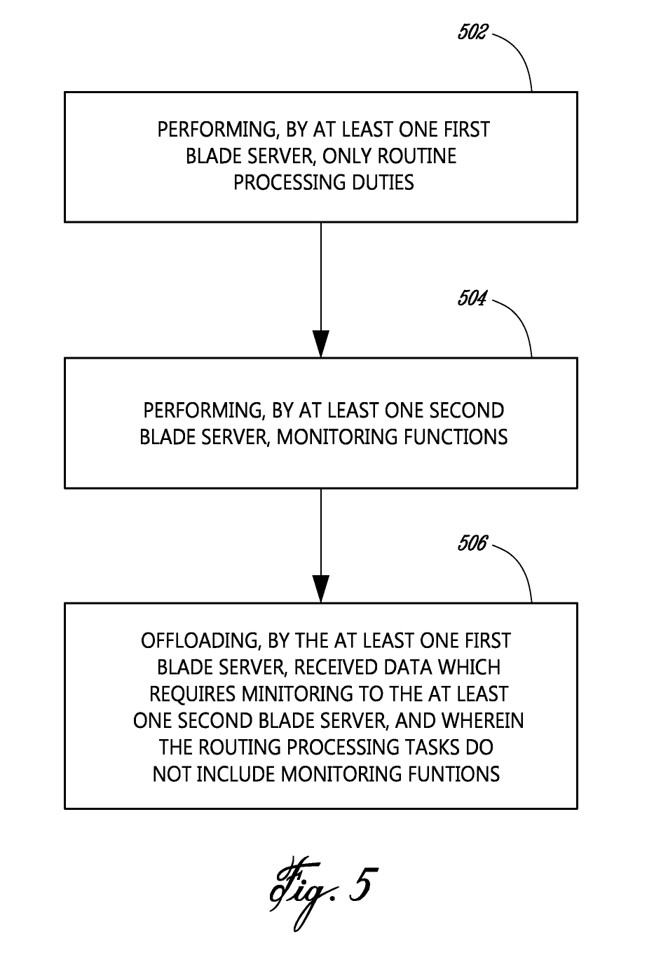

An exemplary method for processing data by a blade enclosure is illustrated in FIG. 5. Therein, at step 502, performing, by at least one first blade server, only routine processing duties; at step 504, performing, by at least one second blade server, monitoring functions; and at step 506, offloading, by the at least one first blade server, received data which requires monitoring to the at least one second blade server, and wherein the routing processing tasks do not include monitoring functions.

The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A blade enclosure for processing data comprising:
at least one first blade server configured to only perform routine processing tasks; and
at least one second blade server connected to the at least one first blade server and configured to perform monitoring functions, wherein the at least one first blade server is configured to offload received data which requires monitoring to the at least one second blade server, and wherein the routine processing tasks do not include monitoring functions.

2. The blade enclosure of claim 1, wherein said at least one first blade server is configured to offload said received data based upon at least one of: an availability of monitoring enabled blade servers, a processing work load estimate for monitoring a particular execution path and a specific configuration of a system in terms of resource management.

3. The blade enclosure of claim 1, wherein the at least one second blade server is further configured to perform the routine processing tasks.

4. The blade enclosure of claim 3, wherein the at least one second blade server executes a same source code as the at least one first blade server.

5. The blade enclosure of claim 1, wherein the monitoring functions include at least one of debugging, tracing and logging functions.

6. The blade enclosure of claim 1, wherein the at least one second blade server has at least one processor specifically configured to support monitoring functions, wherein the at least one first blade server does not have at least one processor specifically configured to support monitoring functions.

7. The blade enclosure of claim 1, wherein a predetermined processing bandwidth for the routine processing tasks can be maintained by the at least one first blade server while monitoring functions are being conducted by the at least one second blade server.

8. The blade enclosure of claim 1, further comprising:
software functions executed by the at least one second blade server to support monitoring functions.

9. The blade enclosure of claim 1, wherein the at least one second blade server is two or more second blade servers, wherein when the two or more second blade servers are performing monitoring functions which have a dependency, the two or more blade servers can be controlled in a synchronous manner.

10. The blade enclosure of claim 1, wherein routine processing includes processing a request to access a link.

11. A method for processing data by a blade enclosure, the method comprising:
performing, by at least one first blade server, only routine processing duties;
performing, by at least one second blade server, monitoring functions; and
offloading, by the at least one first blade server, received data which requires monitoring to the at least one second blade server, and wherein the routing processing tasks do not include monitoring functions.

12. The method of claim 11, wherein the step of offloading is based upon at least one of: an availability of monitoring enabled blade servers, a processing work load estimate for monitoring a particular execution path and a specific configuration of a system in terms of resource management.

13. The method of claim 11, further comprising:
performing, by the at least one second blade server, the routine processing duties.

14. The method of claim 13, wherein the at least one second blade server executes a same source code as the at least one blade server.

15. The method of claim 11, wherein the monitoring functions include at least one of debugging, tracing and logging functions.

16. The method of claim 11, wherein the at least one second blade server has at least one processor specifically configured to support monitoring functions, wherein the at least one first blade server does not have at least one processor specifically configured to support monitoring functions.

17. The method of claim 11, further comprising:
maintaining, by the at least one first blade server, a predetermined processing bandwidth for the routine processing tasks while monitoring functions are being conducted by the at least one second blade server.

18. The method of claim 11, further comprising:
executing, by the at least one second blade server, software functions to support monitoring functions.

19. The method of claim 11, wherein the at least one second blade server is two or more second blade servers, wherein when the two or more second blade servers are performing monitoring functions which have a dependency, the two or more blade servers can be controlled in a synchronous manner.

20. The method of claim 11, wherein routine processing includes processing a request to access a link.
